(19) United States
(12) Patent Application Publication
(10) Pub. No.: US 2024/0077316 A1
(43) Pub. Date: Mar. 7, 2024

(54) LANE DETECTION SYSTEM AND VEHICLE EQUIPPED WITH THE SAME

(71) Applicants: Hyundai Motor Company, Seoul (KR); Kia Corporation, Seoul (KR)

(72) Inventor: Da Yeon Park, Seoul (KR)

(21) Appl. No.: 18/214,236

(22) Filed: Jun. 26, 2023

(30) Foreign Application Priority Data
Sep. 1, 2022 (KR) 10-2022-0110702

(51) Int. Cl. G01C 21/30; B60W 60/00

(52) U.S. Cl. CPC G01C 21/30; B60W 60/001; B60W 2420/42; B60W 2520/06; B60W 2552/53

(57) ABSTRACT

A system for detecting a host vehicle driving lane includes a surrounding information sensor that obtains surrounding information of a host vehicle, a memory that stores HD map data, and a processor that detects the host vehicle driving lane, where the processor receives the surrounding information and the HD map data, outputs matching results based on matching between the surrounding information and the HD map data for respective candidate locations on a plurality of candidate lanes, outputs respective accumulative results for the respective candidate locations according to the matching results and quality information of the surrounding information sensor, and determines the host vehicle driving lane among the plurality of candidate lanes according to the accumulative results.

### CROSS-REFERENCE TO RELATED APPLICATION

The present application claims under 35 U.S.C. § 119(a) the benefit of Korean Patent Application No. 10-2022-0110702, filed on Sep. 1, 2022, the entire contents of which are incorporated herein by reference.

### BACKGROUND

### (a) Technical Field

The present disclosure relates to a system for detecting a host vehicle driving lane and a vehicle including the same, more particularly, to the system for detecting the host vehicle driving lane applied to an autonomous vehicle.

### (b) Description of the Related Art

In order to perform autonomous driving, localization in a level of a travel lane is necessary in order to detect a current driving lane of a host vehicle.

The driving lane detection method disclosed in Korean Registered Publication No. 10-1558786 includes determining a candidate lane using host vehicle localization information based on GPS (Global Positioning System) information, and calculating a matching result by comparing HD (High Definition) map data for each candidate lane with acquired information from a front camera. According to this method, a lane having a maximum matching result value is determined as the driving lane.

The prior art has problems related to sensor performance including GPS information error and erroneous lane recognition due to the use of a single camera, and requires updating to improve the reliability of autonomous driving.

### SUMMARY

The present disclosure discloses a system for detecting a host vehicle lane with improved reliability and a vehicle thereof.

A system for detecting a host vehicle driving lane, according to an embodiment of the present disclosure, comprises an surrounding information sensor configured to obtain surrounding information of the host vehicle, a memory configured to store HD map data, and a processor configured to detect a host vehicle driving lane, wherein the processor is configured to receive the surrounding information and the HD map data, output matching results based on the surrounding information and the HD map data for respective candidate locations on a plurality of candidate lanes, output respective accumulative results for the respective candidate lanes according to the matching results and quality information of the surrounding information sensor, and determine the host vehicle driving lane among the plurality of candidate lanes according to the accumulative results.

In at least one embodiment of the present disclosure, the matching result for each of the plurality of candidate lanes is calculated based on matching between the HD map data of both lane lines for a corresponding candidate location and the surrounding information.

In at least one embodiment of the present disclosure, the matching result is calculated in consideration of a sensing quality of the surrounding information sensor with respect to the surrounding information.

In at least one embodiment of the present disclosure, the sensing quality includes a color quality associated with a lane line color and a type quality associated with a lane line type.

In at least one embodiment of the present disclosure, the matching result is calculated by additionally considering validity of the HD map data.

In at least one embodiment of the present disclosure, the matching result is calculated by multiplying sensing quality values indicating the sensing quality by a validity index of the HD map data.

In at least one embodiment of the present disclosure, the surrounding information sensor includes a front image sensor configured to acquire an image of a front region of the host vehicle and a front image sensor configured to acquire images of front lateral regions of both sides of the host vehicle.

In at least one embodiment of the present disclosure, the quality values includes type quality values of left and right lane-lines which are determined according to a vehicle speed, a sensor quality state of the front image sensor or the front lateral image sensor, a distance related to a gap between a lane line sensed by the front image sensor and a lane line sensed by the front lateral image sensor, and whether lane-line types sensed by the front lateral image sensor and the front lateral image sensor are identical.

In at least one embodiment of the present disclosure, the quality values include color quality values of left and right lane-lines sensed by the front image sensor.

In at least one embodiment of the present disclosure, the processor is further configured to perform at least one of a first process in which the type quality values and the color quality values are all determined to be 0 when there is a change in a lane line type within a predetermined front or rear range with respect to the candidate location, a second process in which the color quality values are all determined to be 0 when all of the colors of the lanes on the HD map data for the plurality of candidate lanes are white and a color other than white is included in the colors of lane lines acquired by the front image sensor, a third process in which the type quality values are all determined to be 0 when at least one triple lane line is included in the lane lines, and a fourth process in which the color quality values are all determined to be 0 when at least one lane line of a color which is neither white nor yellow is included in the lane lines.

In at least one embodiment of the present disclosure, when a difference for a candidate lane among the plurality of the candidate lanes between a lane width on the HD map data and a lane width by the sensing information from the surrounding information sensor is beyond a predetermined range, the matching result for the corresponding candidate lane is determined to be 0.

In at least one embodiment of the present disclosure, the corresponding accumulative result is increased by a predetermined value when the corresponding matching result of a candidate lane is equal to a sum of the sensing quality values, and otherwise decreased by the predetermined value.

In at least one embodiment of the present disclosure, the processor is further configured to receive host vehicle localization information including a time trajectory for each candidate location on the plurality of candidate lanes, the host vehicle localization information obtained through map matching results between the surrounding information and the HD map data.

In at least one embodiment of the present disclosure, the processor transforms the HD map data and the host vehicle localization information into relative coordinates with respect to a location of the host vehicle.

In at least one embodiment of the present disclosure, the host vehicle localization information includes a heading angle for each time of the host vehicle, and wherein the processor is further configured to determine the candidate location on the corresponding candidate lane according to a first time point at which the surrounding information is input, using the corresponding time trajectory, determine a heading angle change of the host vehicle from a second time point at which the HD map data is input to the first time point, using the heading angle for each time, and perform a rotation transformation of the input HD map data according to the heading angle change.

In at least one embodiment of the present disclosure, the plurality of candidate lanes include at least one prime candidate lane and a left candidate lane and a right candidate lane disposed on both sides of the prime candidate lane.

In at least one embodiment of the present disclosure, when the prime candidate lane is changed to another candidate lane among the plurality of candidate lanes, the accumulative results of the plurality of candidate lanes are realigned according to the another candidate lane.

In at least one embodiment of the present disclosure, before the outputting matching points, the processor is further configured for each candidate lane to search for at least one left adjacent lane link and at least one right adjacent lane link from the HD map data, search for a left road link to which the at least one left adjacent lane link belongs and a right road link to which the at least one right adjacent lane link belongs, search for both lane sides of the left and right adjacent lane links among lane sides belonging to the left and right road links, and extract two lane sides disposed at both sides of the each candidate location from the both lane sides of the left and right adjacent lane links.

In at least one embodiment of the present disclosure, the at least one left adjacent lane link or the at least one right adjacent lane link includes a first adjacent lane link and a second adjacent lane link, and the processor is further configured to: determine a lane width of a left or right lane from first adjacent lane information and second adjacent lane information of a left or right side obtained from the surrounding information, and determine the matching result of a corresponding candidate location as O when the lane width is equal to or greater than a predetermined value and there is no lane side corresponding to the lane of which the lane width is determined among the searched lane sides.

A vehicle according to an embodiment of the present disclosure comprises a system as described above.

According to an embodiment of the present disclosure, the reliability is further improved in detecting a host vehicle lane, and thus the reliability of autonomous driving may be improved.

### BRIEF DESCRIPTION OF THE DRAWINGS

FIG. 1 is a conceptual block diagram of a system for detecting a host vehicle driving lane according to an embodiment of the present disclosure.

FIG. 2 is a flowchart illustrating a process of determining a host vehicle driving lane according to an embodiment of the present disclosure.

FIG. 3 is a flowchart illustrating an embodiment of a process of extracting HD map data for lane information of FIG. 2.

FIG. 4 is a flowchart illustrating an embodiment of a calculation process of matching results of FIG. 2.

FIG. 5 is an example where positions of a plurality of candidate lanes are displayed on HD map data in the system detecting host vehicle driving lane according to the exemplary embodiment of the present disclosure.

FIG. 6 illustrates an example regarding a front camera, a left front camera, a right front camera, and an angle of view mounted on a host vehicle.

FIG. 7 is an exemplary drawing that describes coordinate transformation of HD map data P(x, y) according to an angle change of a host vehicle heading.

FIG. 8 is a diagram illustrating a left lane line sensed by the front camera and a left lane line sensed by the left front lateral camera together with reference to the host vehicle.

FIG. 9 is a drawing illustrating a case where there is a lane line type change in a predetermined range in front and rear of a host vehicle lane.

FIG. 10 shows an example of a host vehicle candidate location as one of embodiments of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Furthermore, in describing the exemplary embodiments, when it is determined that a detailed description of related publicly known technology may obscure the gist of the exemplary embodiments, the detailed description thereof will be omitted. The accompanying drawings are used to help easily explain various technical features and it should be understood that the exemplary embodiments presented herein are not limited by the accompanying drawings. Accordingly, the present disclosure should be construed to extend to any alterations, equivalents and substitutes in addition to those which are particularly set out in the accompanying drawings.

Although terms including ordinal numbers, such as “first”, “second”, etc., may be used herein to describe various elements, the elements are not limited by these terms. These terms are generally only used to distinguish one element from another.

When an element is referred to as being “coupled” or “connected” to another element, the element may be directly coupled or connected to the other element. However, it should be understood that another element may be present there between. In contrast, when an element is referred to as being “directly coupled” or “directly connected” to another element, it should be understood that there are no other elements there between.

Unless otherwise defined, all terms including technical and scientific ones used herein have the same meanings as those commonly understood by one of ordinary skill in the art to which this disclosure belongs. It will be further understood that terms, such as those defined in commonly used dictionaries, should be interpreted as having meanings consistent with their meanings in the context of the relevant art and the present disclosure, and are not to be interpreted in an idealized or overly formal sense unless expressly so defined herein.

Furthermore, the term “unit” or “control unit” included in the names of a hybrid control unit (HCU), a motor control unit (MCU), etc. is merely a widely used term for naming a controller configured for controlling a specific vehicle function, and does not mean a generic functional unit. For example, each controller may include a communication device that communicates with another controller or a sensor to control a function assigned thereto, a memory that stores an operating system, a logic command, input/output information, etc., and one or more processors that perform determination, calculation, decision, etc. necessary for controlling a function assigned thereto.

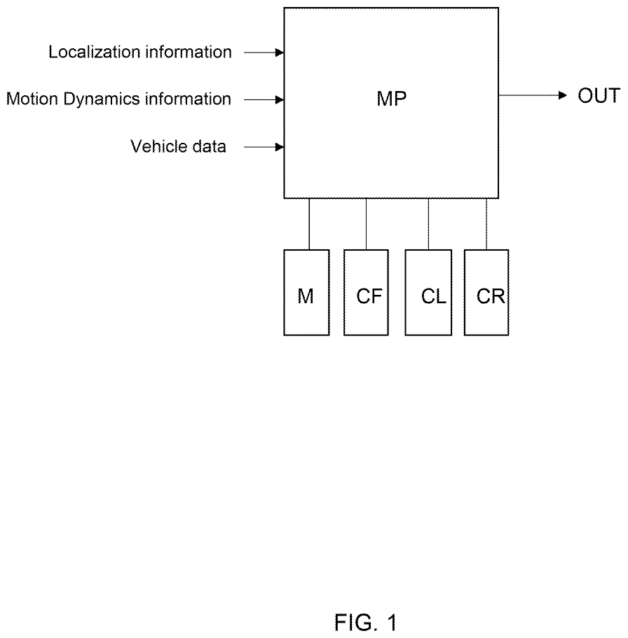

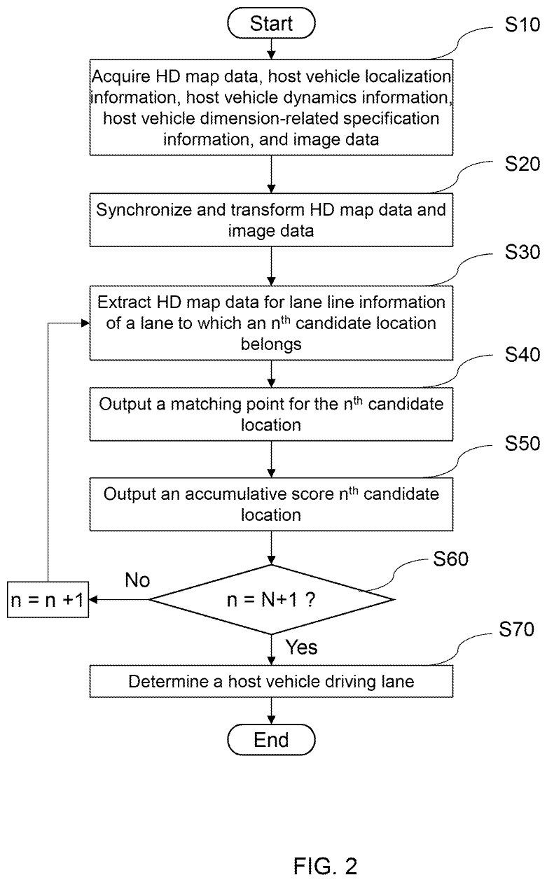

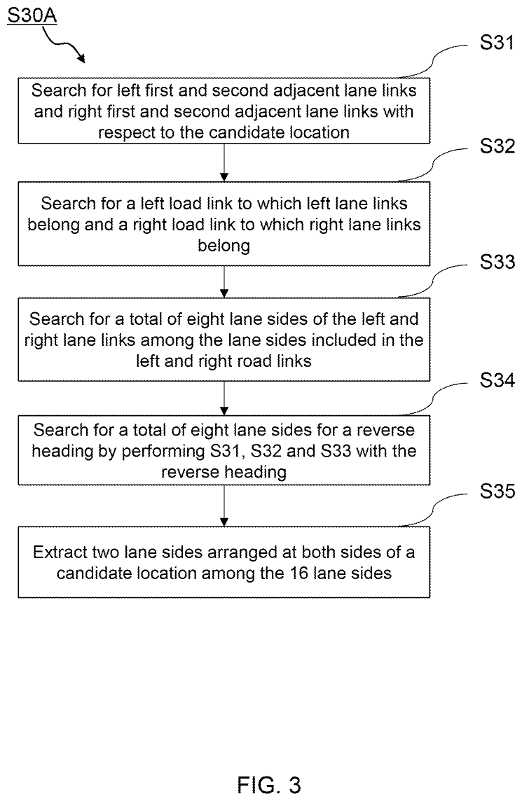

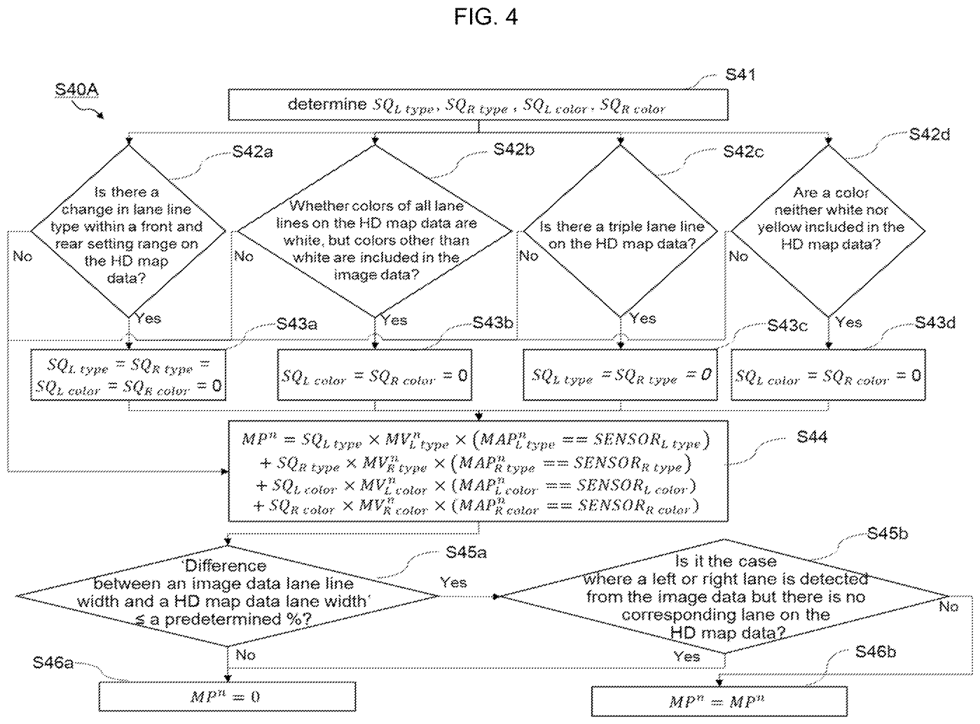

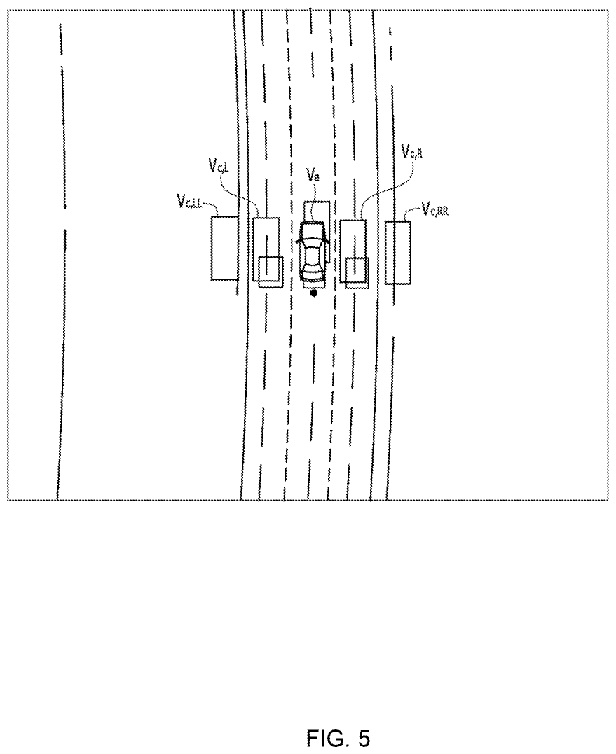

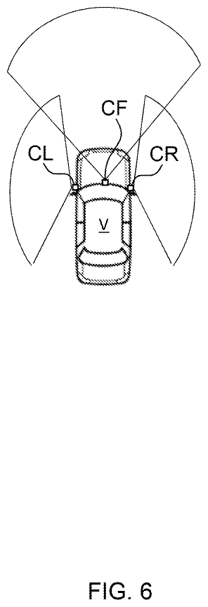

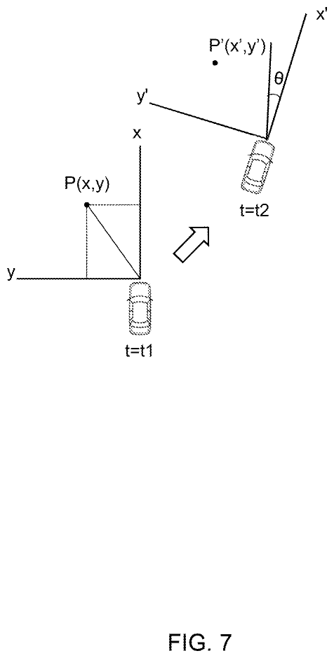

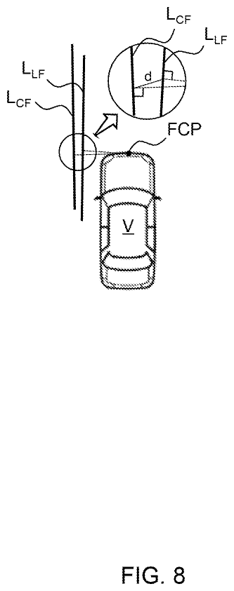

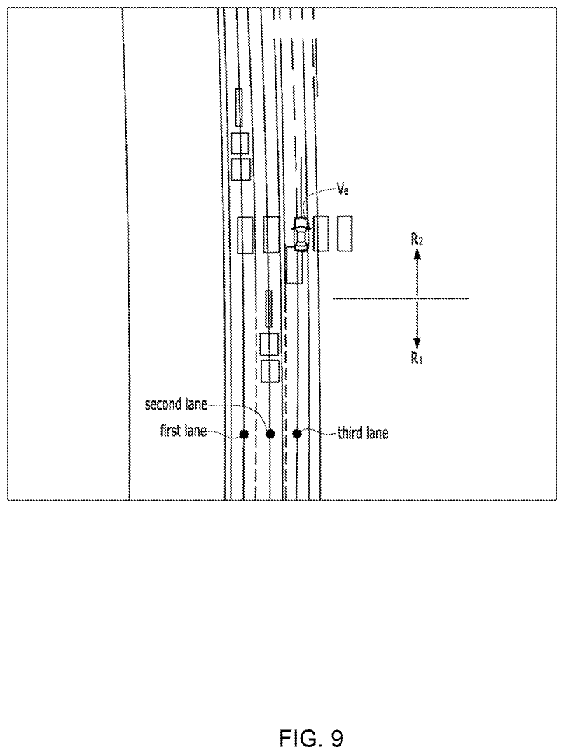

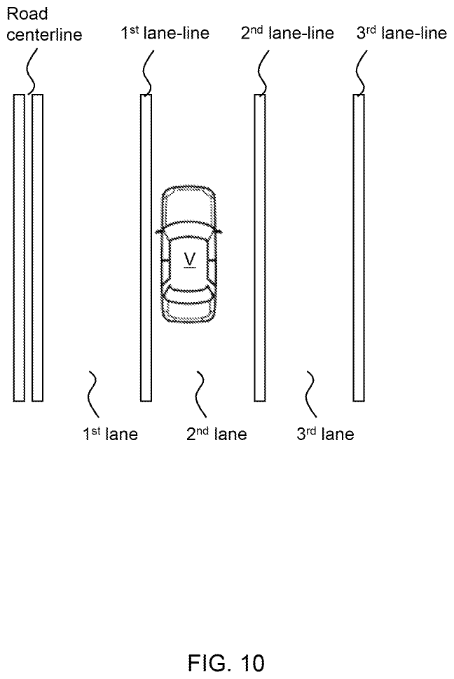

Briefly describing the accompanying drawings, FIG. 1 is a conceptual block diagram of a system for detecting a host vehicle driving lane according to an embodiment of the present disclosure, FIG. 2 is a flowchart illustrating a process of determining a host vehicle driving lane according to an embodiment of the present disclosure, FIG. 3 is a flowchart illustrating an embodiment of a process of extracting HD map data for lane information of FIG. 2, FIG. 4 is a flowchart illustrating an embodiment of a calculation process of matching results of FIG. 2, FIG. 5 is an example where positions of a plurality of candidate lanes are displayed on HD map data in the system detecting host vehicle driving lane according to the exemplary embodiment of the present disclosure, FIG. 6 illustrates an example regarding the scope of a front camera, a left front camera, a right front camera, and an angle of view mounted on a host vehicle, FIG. 7 is an exemplary drawing that describes coordinate transformation of HD map data P(x, y) according to an angle change of a host vehicle heading, FIG. 8 is a diagram illustrating a left lane line sensed by the front camera and a left lane line sensed by the left front lateral camera together with reference to the host vehicle, FIG. 9 is a drawing illustrating a case where there is a lane line type change in a predetermined range in front and rear of a host vehicle lane, and FIG. 10 shows an example of a host vehicle candidate location as one of embodiments of the present disclosure.

Referring to FIG. 1, a system for detecting a host vehicle driving lane according to an exemplary embodiment of the present disclosure includes surrounding information sensors CF, CL, and CR for obtaining surrounding information of the host vehicle, a non-transitory computer-readable memory (e.g., a hard disk drive (HDD), a solid-state drive (SSD), a silicon disk drive (SDD), a ROM, a RAM, a CD-ROM, a magnetic tape, a floppy disk, an optical data storage device, etc.) M that stores HD map data and/or instructions or one or more program code executable by a processor for the detecting of a host vehicle driving lane, and a processor (e.g. computer, microprocessor, CPU, ASIC, circuitry, logic circuits, etc.) MP for performing one or more driving lane detection processes to detect the host vehicle driving lane by executing the instructions or one or more program code.

For example, information such as host vehicle localization information, information of motion dynamics of the vehicle, vehicle data, and the like may be used in order to detect the driving lane.

Here, the host vehicle localization information may include candidate lanes information for the host vehicle driving lane, and each candidate lane information may include at least one candidate location existing on the corresponding lane. Here, for instance, the candidate location on each candidate lane represents a location of the host vehicle (e.g., a location of a center point of the front bumper of the host vehicle) that is temporarily determined on the corresponding lane.

For the host vehicle localization information, for example, one or more predetermined processes (hereinafter, referred to as “localization determination process”) for positioning the host vehicle may be executed in the processor MP or another processor, and a prime candidate location (i.e., a location determined as most likely to be the real location of the host vehicle) for the host vehicle location may be output as a result of the execution.

A corresponding lane, i.e., a prime candidate lane, may be determined from the prime candidate location and the HD map data, and additional candidate lanes may be determined to both sides thereof and included in the host vehicle localization information.

The total number of candidate lanes is pre-determined to be N, and does not necessarily need to match the number of lanes on the HD map data. For example, if N is 5 and three lanes are provided on the HD map data, a virtual lane spaced a predetermined interval (e.g., a standard width of a lane) apart from each candidate location on both end lanes may be determined as an additional candidate lane.

The host vehicle localization information may include a time trajectory for each candidate location and may include predetermined tag information for each candidate lane.

As an example, when five candidate lanes are assumed in reference to FIG. 4, the tag information includes “center” (VE), “left” (VC, L), “left-left” (VC, LL), “right” (VC, R), and “right-right” (VC, RR), etc., and the “center” tag is assigned to a lane corresponding to the prime candidate location, the “left” tag to the immediately left candidate lane, the “right” tag to the immediately right candidate lane, the “left-left” tag to the left candidate lane of the left candidate lane, and the “right-right” to the right candidate lane of the right candidate lane.

The localization determination process may include a map matching process for the surrounding information around the host vehicle detected by the sensor and the HD map data, and the prime candidate location may be determined through a result of the map matching process.

The host vehicle dynamics information includes at least a speed of the host vehicle.

The vehicle data of the host vehicle may include, for example, the shortest distance from a center point of the rear wheel shaft to the front bumper and a distance from the center of the vehicle to a left (or right) front lateral image sensor, which will be described later.

The environmental information sensors CF, CL, and CR include image sensors.

The image sensor may include a front image sensor CF and left and right front lateral image sensors CL and CR.

In the present embodiment, a camera is used as the image sensor. In particular, a front camera CF, a left front lateral camera CL, and a right front lateral camera CR may be used with reference to FIG. 1.

As shown in FIG. 6, for example, the front camera CF acquires a front image of the host vehicle with a range of a predetermined angle, the left front lateral camera CL acquires an image (hereinafter, referred to as a “left image”) of a left, front and lateral side of the vehicle with a predetermined range, and the right front lateral camera CR acquires an image (hereinafter, referred to as a “right image”) of a right, front and lateral side of the vehicle with a predetermined range.

Here, the front image includes at least left and right lane lines of the host vehicle driving lane, the left image includes at least a left lane line of the driving lane, and the right image includes at least a right lane line of the driving lane.

Each image goes through a predetermined image processing, and information of a lane line may be output as a result including a color and a type for each lane line.

That is, as a result of image processing on the front image, information on left and right lines of the driving lane is output, as a result of image processing on the left image, information on the left lane line of the driving lane is output, and as a result of image processing on the right image, information on the right lane line of the driving lane is output.

In addition, the information of each lane line may include position information (i.e., a distance from the host vehicle) in addition to the color and the type. However, the present embodiment is not limited thereto.

The HD map data may be acquired, continuously while the vehicle being driven, by predetermined areas ahead of and behind the host vehicle from an external map server, and may be stored and updated in the memory M.

The HD map data may include precise lane-level information, and may include data such as lane links, lane sides, and road sides.

A lane link is a form of data for the center of a lane, defined as a segment, and the lane link data may include shape information including positions of end points for the segment, the number of front and rear lane links, and ID information.

A lane side is a form of data for a lane line, defined as a segment, and the lane side data may include shape information including positions of end points for the segment, and color and type information of the segment.

Further, a road side is a form of data for a road, and the road side data may include road type information such as a highway, a general road, and others, and information about the number of lane links and lane sides belonging to the corresponding road side.

The processor MP executes a driving lane detection process using the above information and based on the surrounding information acquired through the surrounding information sensors CF, CL, and CR and the HD map data to detect a host vehicle driving lane.

The driving lane detection process outputs a matching result based on the matching between surrounding information obtained by the surrounding information sensors (CF, CL, CR) and HD map data for each candidate location on each of the plurality of candidate lanes, outputs an accumulated result for each candidate lane according to the matching result for each candidate lane and quality information of the sensor, and determines a driving lane depending on the accumulated result for each candidate lane.

Hereinafter, a driving lane detection process of the present embodiment will be described in detail with reference to FIGS. 2 to 4.

First, in step S10, host vehicle localization information, information of motion dynamics of a host vehicle, host vehicle specification information (i.e., vehicle data of the host vehicle such as the shortest distance from a center point of the rear wheel shaft to the front bumper and a distance from the center of the vehicle to a left (or right) front lateral image sensor), and HD map data and image data are obtained.

As described above, the host vehicle localization information includes N (the number of candidate lanes and 5 in this embodiment) candidate lanes including a prime candidate lane, tag information thereof, a time trajectory of a candidate location on each candidate lane, a host vehicle heading angle according to time, etc.

The host vehicle localization information may conform to the ENU coordinate system, and after being input to the processor, the host vehicle localization information may be transformed into a relative coordinate system having the host vehicle location (e.g., the center point of the rear wheel axis of the host vehicle) as the origin.

As described above, the image data is acquired by use of the front camera CF and the front lateral cameras CL and CR, and includes lane line information after the image processing.

The HD map data is read in from the memory M, and transformed into a relative coordinate system having a location of the host vehicle (for example, the central point of the rear wheel axis of the host vehicle) as the origin.

Here, since there may be a difference, though slight, between the time point at which the HD map data is input from the memory M (hereinafter, referred to as a “HD map time point”) and the time point at which the image is acquired or the time point at which the image is input to the processor MP (hereinafter, referred to as an “image time point”), synchronization and rotational transformation of the HD map data and the image data may be required in step S20. However, the present embodiment is not necessarily limited thereto.

For example, as shown in FIG. 7, the HD map time point t1 and the image time point t2 may differ from each other, and during the time change between the time points, the heading angle of the host vehicle may change by a heading angle change θ.

The HD map data transformed into the relative coordinate system may require a rotational transformation of coordinates depending on the heading angle change θ according to

$$( \begin{matrix}{x}^{′} \\ {y}^{′}\end{matrix} ) = ( \begin{matrix}cos θ & - sin θ \\ sin θ & cos θ\end{matrix} ) ( \begin{matrix}x \\ y\end{matrix} ) \qquad Equation 1$$

wherein θ is positive in the clockwise direction.

In this case, each candidate location on the plurality of candidate lanes may be determined by extracting a location of an image time point from a corresponding time trajectory included in the host vehicle localization information.

When the processes of synchronization and transformation are completed, steps S30 to S50 are performed for each candidate location on each candidate lane, and are repeated until the N candidate lanes are done.

In step S30, HD map data for information on both left and right lane lines of a lane to which a candidate location belongs is extracted.

Hereinafter, an embodiment of a process of extracting HD map data for lane line information will be described in detail through the flowchart shown in FIG. 3.

First, in step S31, the lane link (hereinafter, referred to as “left first adjacent lane link”) firstly closest and the lane link (hereinafter, referred to as “left second adjacent lane link”) secondly closest to the left from the candidate location, the lane link (hereinafter, referred to as “right first adjacent lane link”) first closest and the lane link (hereinafter, referred to as “right second adjacent lane link”) second closest to the right from the candidate location are searched for and output from the HD map data.

Next, in step S32, a road link (hereinafter, referred to as a “left road link”) to which the left first and second adjacent lane links belong and a road link (hereinafter, referred to as a “right road link”) to which the right first and second adjacent lane links belong are searched for and output from the HD map data.

Next, in step S33, eight lane sides of the left first and second adjacent lane links and the right first and second adjacent lane links are searched for and output among the lane sides included in the left and right road links.

In the HD map data, each road link or each lane link has a predetermined traveling direction, and when the GPS is used at the time of the initial localization determination, candidate locations may be determined on the opposite lanes (the opposite direction roads or the lane links on the HD map data) due to an error in the GPS location, and thus it is preferably required to perform the steps S31 to S33 for the opposite lanes too. To this end, the above steps S31 to S33 may be repeatedly performed by applying the reverse heading direction.

When the step S34 is completed, a total of 8 lane links and their lane sides, i.e., a total of 16 lane sides are output as the search result.

In step S35, two lane sides disposed at both sides of the candidate location are finally extracted from the 16 lane sides.

By extracting the lane sides at both sides of the candidate location through the above process, the lane information at both sides of the candidate location may be extracted without confusion among the bifurcating lane and the main lane at a bifurcation.

In the present embodiment, the lane links are searched for up to the second adjacent ones at the left and right sides, but the present disclosure is not limited thereto. For example, only the first adjacent lane links may be searched for.

The reason, in the present embodiment, of searching for up to the second adjacent lane links is to determine whether there is a left or right lane on the HD map data in step S45b, which will be described below

For description, it is assumed that a candidate location for host vehicle V is shifted to the left from the center of the second lane as shown in FIG. 10. In this case, the right first adjacent lane link corresponds to the second lane, and the right second adjacent lane link corresponds to the third lane. If the second adjacent lane link is not searched for in the situation of FIG. 10, the counterpart HD map data to be matched to the right lane detected through the image data in step S45b cannot be determined, and thus the step S45b cannot be performed.

Referring back to the flowchart of FIG. 2, after step S30, a matching result will be output for the candidate location.

The step of outputting a matching result will be described in detail with reference to the embodiment of FIG. 4.

First, the matching result for the corresponding candidate location can be calculated in step S44 according to

MPⁿSQ_{L type}×MV_{L type}ⁿ×(MAP_{L type}ⁿ==SENSOR_{L type})+SQ_{R type}×MV_{R type}ⁿ×(MAP_{R type}ⁿ==SENSOR_{R type})+SQ_{L color}×MV_{L color}ⁿ×(MAP_{L color}ⁿ==SENSOR_{L color})+SQ_{R color}×MV_{R color}ⁿ×(MAP_{R color}ⁿ==SENSOR_{R color}) Equation 2:

Here, n denotes an n^{th} lane among N candidate lanes, and MP denotes a matching result.

SQ_{L type} denotes a type quality result for a left lane line of the image sensors CF and CL, and SQ_{R type} denotes a type quality result for a right lane line of the image sensors CF and CR.

Further, SQ_{L color} denotes a color quality result for a left lane line of the image sensors CF and CL, and SQ_{R color} denotes a color quality result for a right lane line of the image sensors CF and CR.

MV is a validity index of HD map data having a value of 0(zero) or 1. For example, when any of the type and color information of the lane line information is not available, it may have a value of 0, and when all the type and color information are present, it may be set to 1.

For example, the MV may be determined by the processor MP performing validity check while reading corresponding data, regardless of whether some of the data is lost during the read-in process or is originally missing in the HD map data stored in the memory M.

MAP_{L type} denotes HD map data for a left lane line type, and MAP_{R type} denotes HD map data for a right lane line type.

In addition, MAP_{L color} denotes HD map data for the left lane line color, and MAPR color denotes HD map data for the right lane line color.

In addition, SENSOR_{L type} denotes sensing information of the image sensors CF and CL with respect to a left lane line type, and SENSOR_{R type} denotes sensing information of the image sensors CF and CR with respect to a right lane line type.

SENSOR_{L color} denotes sensing information of the image sensors CF and CL with respect to a left lane line color, and SENSOR_{R color} denotes sensing information of the image sensors CF and CR with respect to a right lane line color.

In order to calculate the equation of step S44, the SQ_{L type}, SQ_{R type}, SQ_{L color}, and SQ_{R color} are determined earlier in steps S41, S42a to S42d, and S43a to S43d, which will be described in detail below.

First, in step S41, the SQ_{L type} is determined according to the following Table 2 with the values of the first condition and the second condition determined in Table 1.

TABLE 1

| | Condition | Condition | Condition | Condition | |
|---|---|---|---|---|---|
| | for vehicle | for sensor | for | for | Conditional |
| | speed | quality | Shape | Type | value |
| Left lane line | exceeding a | step five | d <= setting | same | 1 (if all the |
| type quality | predetermined | | value | | left |
| condition of a | speed | | | | conditions are |
| front image | | | | | satisfied), or |
| sensor (first | | | | | 0 (otherwise) |
| condition) | | | | | |
| Left lane line | N/A | more than | d <= setting | same | 1 (if all the |
| type quality | | step four | value | | left |
| condition of a | | | | | conditions are |
| front lateral | | | | | satisfied), or |
| image sensor | | | | | 0 (otherwise) |
| (second | | | | | |
| condition) | | | | | |

TABLE 2

| Value for the | Value for the | SQL |
|---|---|---|
| First condition | Second condition | type |
| 1 | 1 | 2 |
| 0 | 1 | 1 |
| 1 | 0 | 1 |
| 0 | 0 | 0 |

In Table 1, the condition for sensor quality is divided into steps 1 to 5, and a higher step indicates a better quality. The condition for sensor quality may be determined based on preset criteria for the image sensor or an image processing result.

Referring to FIG. 8, “d” for the condition for shape in Table 1 indicates a distance between a left lane line LCF detected by the front image sensor CF and a left lane line LLF detected by the front lateral image sensor CL. For example, the “d” may be defined as a distance between two points vertically intersecting the left lane line LCF and the left lane line LLF from a candidate location corresponding to the center point FCP of the front bumper of the host vehicle.

In Table 1, the “same” for the condition for type means that the left lane line type detected by the front image sensor CF is the same as the left lane line type detected by the front lateral image sensor CL.

In addition, SQ_{R type} is determined according to Table 4 below with the values determined for the third and fourth conditions in Table 3 below according to right lane line type information of the front image sensor CF and the right lane line type information of the front lateral image sensor CR, similarly to the SQ_{L type}.

TABLE 3

| | Condition | Condition | Condition | Condition | |
|---|---|---|---|---|---|
| | for vehicle | for sensor | for | for | Conditional |
| | speed | quality | Shape | type | value |
| Right lane line | exceeding a | step five | d <= setting | same | 1 (if all the |
| type quality | predetermined | | value | | left |
| condition of a front | speed | | | | conditions are |
| image sensor (third | | | | | satisfied), or |
| condition) | | | | | 0 (otherwise) |
| Right lane line | N/A | more than | d <= setting | same | 1 (if all the |
| type quality | | step four | value | | left |
| condition of a front | | | | | conditions are |
| lateral image | | | | | satisfied), or |
| sensor (fourth | | | | | 0 (otherwise) |
| condition) | | | | | |

TABLE 4

| Value for the | Value for the | SQR |
|---|---|---|
| third condition value | fourth condition value | type |
| 1 | 1 | 2 |
| 0 | 1 | 1 |
| 1 | 0 | 1 |
| 0 | 0 | 0 |

SQ_{L color} may be determined to be 1 if the first condition for the left lane line type information of the front image sensor CF is satisfied, and otherwise, 0, and SQ_{R color} may be determined to be 1 if the third condition for the right lane line type information of the front image sensor CF is satisfied, and otherwise, 0.

Although SQ_{L type}, SQ_{R type}, SQ_{L color}, and SQ_{R color} are determined in step S41, the values may be changed when respective restriction conditions are satisfied in steps S42a to S42d.

First, as a first restriction condition, when there is a change in the lane line type in the HD map data within front and/or rear predetermined ranges with respect to the candidate location in step S42a, SQ_{L type}, SQ_{R type}, SQ_{L color}, and SQ_{R color} are all determined to be 0 in step S43a.

FIG. 9 illustrates a case where the left lane line is solid-dotted in the lower predetermined range R1 for the third lane on the HD map data, and the lane line type is changed to be solid-solid in the upper predetermined range R2.

Next, as a second restriction condition, when the colors of all the lane lines on the HD map data is white for the N candidate lanes and a color other than white is included in the lane line colors detected by the front image sensor in step S42b, both SQ_{L color} and SQ_{R color} are determined to be 0 in step S43b.

Next, as a third restriction condition, when at least one triple lane line is included in the lane lines of the N candidate lanes in step S42c, both SQ_{L type} and SQ_{R type} are determined to be 0 in step S43c.

Finally, as a fourth restriction condition, when at least one lane the color of which is neither white nor yellow is included in the lane lines of the N candidate lanes in step S42d, both SQ_{L color} and SQ_{R color} are determined to be 0 in step S43d.

The lane line type may include, for example, a “single solid line”, a “left-dotted right-solid line”, a “left-solid right-dotted line”, a “double solid line”, a “single dotted line”, and the like, and such definitions of the lane line types for the front image sensor CF and the front lateral image sensors CL and CR may be different.

For example, for the definition of the lane line type for the front image sensor CF, a “single solid line” may be defined as a “solid line”, a left lane line of the “left-dotted right-solid line” and a right lane line of the “left-solid right-dotted line” may be defined as an “inner solid line”, a left lane line of the “left-solid right-dotted line” and a right lane line of the “left-dotted right-solid line” may be defined as an “inner dotted line”, a “double solid line” may be defined as a “double solid line”, and a “single dotted line” may be defined as a “dotted line”.

For the definition of a lane line type for the left front lateral image sensor CL, a “single solid line” may be defined as a “solid line”, a “left-dotted right-solid line” may be defined as a “right solid line”, a “left-solid right-dotted line” may be defined as a “right dotted line”, and a “single dotted line” may be defined as a “dotted line”.

For the definition of the lane line type for the right front lateral image sensor CR, a “single solid line” may be defined as a “solid line”, a “left-dotted right-solid line” may be defined as a “left dotted line”, a “left-solid right-dotted line” may be defined as a “left solid line”, and a “single dotted line” may be defined as a “dotted line”.

In this case, the lane line type for the front image sensor CF and the lane line type for the front lateral image sensors CL and CR may need to be merged into one data form according to the form of the HD map data to be compared with. However, the present embodiment is not limited thereto.

For example, in the case of the left lane line, when the lane line type detected by the front image sensor CF is any of the “solid line”, the “inner solid line”, and the “double solid line”, and the lane line type detected by the left front lateral image sensor CL is any of the “solid line”, the “right solid line”, and the “double solid line”, it is merged into a “solid line”. Further, in the case of the left lane line, when the lane line type detected by the front image sensor CF is any one of a “dotted line” and an “inner dotted line”, and when the lane line type detected by the left front lateral image sensor CL is any of the “dotted line” and the “right dotted line”, the left lane line is merged into a “dotted line”.

Further, for example, in the case of the right lane line, when the lane line type detected by the front image sensor CF is any of the “solid line”, the “inner solid line”, and the “double solid line”, and when the lane line type detected by the right front image sensor CR is any of the “solid line”, the “left solid line”, and the “double solid line”, it is merged into a “solid line”. Further, in the case of the right lane line, when the lane type detected by the front image sensor CF is any one of a “dotted line” and an “inner dotted line”, and when the lane line type detected by the right front lateral image sensor CR is any one of a “dotted line” and a “left dotted line,” it is merged into a “dotted line”.

After the matching result is determined in step S44, when the difference between the lane width on the image data and the lane width on the HD map data for the corresponding candidate lane exceeds the predetermined range in step S45a (i.e., No in S45a), the calculated matching result is determined as 0.

When a candidate lane is branched into two lanes or merged with another lane, there may be a large discrepancy in the road width of the branched lane or the sub-merged lane than the main lane. In this case, when the host vehicle is on the main lane, there is a large discrepancy between the lane width on the image data and the lane width of the HD map data which the branched lane or the sub-merged lane is the candidate lane, and the corresponding candidate lane can be effectively excluded from the determination of the driving lane. If step S45 is not provided, the matching results may be determined as the same value for both cases of when the main lane is the candidate lane and when the branched lane or the sub-merged lane is the candidate lane so that an error of determining the driving lane as a wrong lane may occur.

Next, in step S45b, when the left or right lane is detected on the image data but the corresponding lane does not exist on the HD map data (Yes in S45b), the calculated matching result is determined to be 0, otherwise, the calculated value is maintained as it is already determined (No in S45b).

For step S45b, a first adjacent lane line and a second adjacent lane line on the left or right side are extracted from the image data, and the width between them is calculated to confirm the presence of the left or right lane. For example, the width between the first adjacent lane line and the second adjacent lane line may be calculated, and when the width is equal to or greater than a predetermined value, it may be determined that the corresponding lane exists. Further, the existence of a lane corresponding to the left or right lane identified from the image data is identified from the 16 pieces of lane side information searched in step S31 using the lane side information on both sides of the candidate location extracted in step S35.

For example, it is assumed that the host vehicle drives on a second lane from the right side of the three-lane road. In this case, the rightmost lane may be determined as the candidate location of the host vehicle due to an initial localization error due to a GPS error. In this case, a right lane may be detected from the sensor data, but a right lane of a corresponding candidate location may not be determined from the HD map data. Therefore, in this case, it may be immediately determined that the corresponding candidate lane is not a driving lane.

Referring back to the flowchart of FIG. 2, after the matching results for the candidate locations are output, accumulated results for the corresponding candidate lanes are output in step S50.

To this end, a sum of SQ_{L type}, SQ_{R type}, SQ_{L color}, and SQ_{R color} used at the time of determining the matching result is calculated, and when the matching result has the same value as the sum, a predetermined value (for example, 10) is added to the existing accumulative results of the corresponding lane, otherwise, the predetermined value is subtracted from the existing accumulative results to output the accumulative results.

For example, when SQ_{L type} and SQ_{R type} are both 0 and SQL color and SQ_{R color} are both 1 at a candidate location, the sum is 2, and when the corresponding matching result is 2, the cumulative result of the corresponding candidate lane is increased by 10.

When the calculation of the accumulative results for all the candidate lanes is completed, the candidate lane that has the largest accumulative result value is determined to be the driving lane in step S70.

By using an accumulative result obtained by accumulatively scoring a driving lane without directly considering the matching result, false detection of the driving lane due to a temporary error or the like can be prevented, thereby obtaining highly reliable results.

For example, each accumulative result may be set to have a value within the range of −100 to 100 for stochastic management of each candidate lane.

For example, each accumulative result for the candidate lanes shown in FIG. 5 can be managed as shown in Table 5 below.

TABLE 5

| | | | | | |
|---|---|---|---|---|---|
| Candidate lane ID | 1 | 2 | 3 | 4 | 5 |
| Candidate lane tag | left-left | left | center | right | right-right |
| Accumulative | 10 | 30 | 80 | 50 | 10 |
| results | | | | | |

In this case, when there is a change in the lane corresponding to the “center” in the newly input host vehicle localization information, that is, when the prime candidate lane among the plurality of candidate lanes has changed, the accumulative results of the plurality of candidate lanes may be rearranged according to the new changed prime candidate lane.

TABLE 6

| | | | | | |
|---|---|---|---|---|---|
| Candidate lane ID | 1 | 2 | 3 | 4 | 5 |
| Candidate lane tag | left-left | left | c | right | right-right |
| Existing | APLL | APL | APC | APR | APRR |
| accumulative | | | | | |
| results | | | | | |
| Changed | APC | APR | APRR | 0 | 0 |
| accumulation | | | | | |
| results | | | | | |
| (case 1) | | | | | |
| Changed | APL | APC | APR | APRR | 0 |
| accumulative | | | | | |
| results | | | | | |
| (case 2) | | | | | |
| Changed | 0 | APLL | APL | APC | APR |
| accumulative | | | | | |
| results | | | | | |
| (case 3) | | | | | |
| Changed | 0 | 0 | APLL | APL | APC |
| accumulative | | | | | |
| results | | | | | |
| (case 4) | | | | | |

As provided herein, case 1 indicates a case where the “center” is changed to the first lane, case 2 indicates a case where the “center” is changed to the second lane, case 3 indicates a case where the “center” is changed to the fourth lane, and case 4 indicates a case where the “center” is changed to the fifth lane.

For example, as shown in Table 6, in a state where the third lane is designated as a “center”, when host vehicle localization information indicating that the “center” is changed to another lane has been input, the accumulative results for the existing candidate lanes are shifted and rearranged according to the change to the “center” lane.

The localization determination process described above may include a map matching process initially using GPS information as the position of the host vehicle, and there may be an error by a width of a lane in the GPS information. Such an error may be corrected in a subsequent localization process, and at this time, the accumulative result for each candidate lane may also be quickly corrected through the rearrangement of the accumulative results.

The above-described embodiments should not be construed as limiting in all respects and should be considered exemplary. The scope of the present embodiment should be determined by rational interpretation of the appended claims, and all changes within the equivalent scope of the present embodiment are included in the scope of the present embodiment.

What is claimed is:

1. A system for detecting a host vehicle driving lane, the system comprising:
a surrounding information sensor configured to obtain surrounding information of the host vehicle;
a memory configured to store high definition (HD) map data; and
a processor configured to detect a host vehicle driving lane,
wherein the processor is configured to:
receive the surrounding information and the HD map data, output matching results based on the surrounding information and the HD map data for respective candidate locations on a plurality of candidate lanes,
output respective accumulative results for the respective candidate locations according to the matching results and quality information of the surrounding information sensor, and
determine the host vehicle driving lane among the plurality of candidate lanes according to the accumulative results.

2. The system of claim 1, wherein the matching results for the plurality of candidate lanes are calculated based on matching between the HD map data of both lane lines for a corresponding candidate location and the surrounding information.

3. The system of claim 2, wherein the matching results are calculated in consideration of a sensing quality of the surrounding information sensor with respect to the surrounding information.

4. The system of claim 3, wherein the sensing quality includes a color quality associated with a lane line color and a type quality associated with a lane line type.

5. The system of claim 4, wherein the matching results are calculated by considering validity of the HD map data.

6. The system of claim 5, wherein the matching results are calculated by multiplying sensing quality values indicating the sensing quality by a validity index of the HD map data.

7. The system of claim 6, wherein the surrounding information sensor includes a front image sensor configured to acquire an image of a front region of the host vehicle and a front lateral image sensor configured to acquire images of front lateral regions of both sides of the host vehicle.

8. The system of claim 7, wherein the quality values includes type quality values of left and right lane-lines which are determined according to a vehicle speed, a sensor quality state of the front image sensor or the front lateral image sensor, a distance related to a gap between a lane line sensed by the front image sensor and a lane line sensed by the front lateral image sensor, and whether lane-line types sensed by the front lateral image sensor and the front lateral image sensor are identical.

9. The system of claim 8, wherein the quality values include color quality values of left and right lane-lines sensed by the front image sensor.

10. The system of claim 9, wherein the processor is further configured to perform at least one of:
a first process in which the type quality values and the color quality values are all determined to be 0 when there is a change in the lane line type within a predetermined front or rear range with respect to the candidate location;
a second process in which the color quality values are all determined to be 0 when all of the colors of lanes on the HD map data for the plurality of candidate lanes are white and a color other than white is included in the colors of the lane lines acquired by the front image sensor;
a third process in which the type quality values are all determined to be 0 when at least one triple lane line is included in the lane lines; and
a fourth process in which the color quality values are all determined to be 0 when at least one lane line of a color which is neither white nor yellow is included in the lane lines.

11. The system of claim 6, wherein when a difference for a candidate lane among the plurality of the candidate lanes between a lane width based on the HD map data and a lane width determined by the sensing information from the surrounding information sensor is beyond a predetermined range, a matching result for the corresponding candidate lane among the plurality of candidate lanes is determined to be 0.

12. The system of claim 6, wherein a corresponding accumulative result is increased by a predetermined value when a corresponding matching result of a candidate lane among the plurality of candidate lanes is equal to a sum of the sensing quality values, and otherwise decreased by the predetermined value.

13. The system of claim 1, wherein the processor is further configured to receive host vehicle localization information including a time trajectory for each candidate location on the plurality of candidate lanes, the host vehicle localization information obtained through map matching results between the surrounding information and the HD map data.

14. The system of claim 13, wherein the processor transforms the HD map data and the host vehicle localization information into relative coordinates with respect to a location of the host vehicle.

15. The system of claim 14, wherein the host vehicle localization information includes a heading angle for each time of the host vehicle, and wherein the processor is further configured to determine the candidate location on the corresponding candidate lane according to a first time point at which the surrounding information is input, using the corresponding time trajectory, determine a heading angle change of the host vehicle from a second time point at which the HD map data is input to the first time point surrounding information, using the heading angle for each time, and perform a rotation transformation of the input HD map data according to the heading angle change.

16. The system of claim 13, wherein the plurality of candidate lanes includes at least one prime candidate lane, and a left candidate lane and a right candidate lane disposed on both sides of the prime candidate lane.

17. The system of claim 16, wherein when the prime candidate lane is changed to another candidate lane among the plurality of candidate lanes, the accumulative results of the plurality of candidate lanes are realigned according to the another candidate lane.

18. The system of claim 1, wherein before outputting matching points, the processor is further configured for each of the candidate lanes to:
search for at least one left adjacent lane link and at least one right adjacent lane link from the HD map data,
search for a left road link to which the at least one left adjacent lane link belongs and a right road link to which the at least one right adjacent lane link belongs,
search for both lane sides of the left and right adjacent lane links among lane sides belonging to the left and right road links, and
extract two lane sides disposed at both sides of each of the candidate locations from the both lane sides of the left and right adjacent lane links.

19. The system of claim 18, wherein the at least one left adjacent lane link or the at least one right adjacent lane link includes a first adjacent lane link and a second adjacent lane link, and wherein the processor is further configured to:
determine a lane width of a left or right lane from first adjacent lane information and second adjacent lane information of a left or right side obtained from the surrounding information, and
determine a matching result of a corresponding candidate location as zero when the lane width is equal to or greater than a predetermined value and there is no lane side corresponding to a lane of which the lane width is determined among the searched lane sides.

20. A vehicle comprising the system for detecting the host vehicle driving lane according to claim 1.
